(19) United States
(12) Patent Application Publication
(10) Pub. No.: US 2026/0102748 A1
(43) Pub. Date: Apr. 16, 2026

(54) INTERNAL MIXER

(71) Applicant: KABUSHIKI KAISHA KOBE SEIKO SHO (KOBE STEEL, LTD.), Hyogo (JP)

(72) Inventors: Hodaka MIURA, Takasago-shi (JP); Hiroomi KATANO, Takasago-shi (JP); Martin C. GREEN, Billerica, MA (US)

(73) Assignee: KABUSHIKI KAISHA KOBE SEIKO SHO (KOBE STEEL, LTD.), Hyogo (JP)

(21) Appl. No.: 19/348,047

(22) Filed: Oct. 2, 2025

Related U.S. Application Data
(60) Provisional application No. 63/707,451, filed on Oct. 15, 2024.

(51) Int. Cl. B01F 27/2322; B01F 101/00

(52) U.S. Cl. CPC B01F 27/2322; B01F 2101/2805

(57) ABSTRACT

An internal mixer includes a mixing chamber having a mixing room, a material input portion that is located above the mixing chamber, a pair of mixing rotors configured to knead a material to be kneaded in the mixing room, a weight disposed in the material input portion so as to be capable of pressing the material to be kneaded in the mixing room from above, a hydraulic circuit having a hydraulic cylinder connected to the weight, and a controller that controls the hydraulic circuit to perform a pressing motion of supplying hydraulic oil to the hydraulic cylinder so that the material to be kneaded is pressed by the weight and a motion for suppressing rapid rise of limiting an operation of the hydraulic cylinder so as to suppress an upward moving speed of the weight when the pressing motion is canceled.

### FIELD OF INVENTION

The present invention relates to an internal mixer.

### BACKGROUND ART

Conventionally, as disclosed in Japanese Patent Application Laid-Open No. 2007-54824, an internal mixer that kneads a material to be kneaded while pressing the material to be kneaded with a weight in a mixing room is known. The internal mixer disclosed in Japanese Patent Application Laid-Open No. 2007-54824 includes a linear scale that detects a lifting position of a weight and a position setting unit that sets the lifting position of the weight. In this internal mixer, lifting position control of the weight is executed so that the position of the weight matches a set value set by the position setting unit. Note that, position control of the weight is performed by ON/OFF control of an electromagnetic direction switching valve.

Japanese Patent Application Laid-Open No. Hei 7-24288 discloses an internal mixer configured to pneumatically control a lifting motion of a weight. The lifting motion of the weight is performed by operating the cylinder by air pressure. At the time of raising the weight, when it is detected that the weight has risen to a preset position while detecting the position of the weight, a shut-off valve is operated to stop the rising motion of the weight.

In addition, an internal mixer is also disclosed in Japanese Patent Application Laid-Open No. Hei 10-211616 and Japanese Patent Application Laid-Open No. Hei 9-206581.

In recent years, materials and additives of a kneading material have been diversified, and there is an increasing need to knead a material to be kneaded containing a large amount of volatile components (moisture) as compared with the related art. In the case of kneading a material to be kneaded containing a large amount of moisture or the like, the moisture or the like vaporizes as the temperature rises during kneading, and thus the internal pressure of the mixing room may rapidly increase. If the control for raising the weight is performed in such a state, the weight may suddenly rise under the influence of the internal pressure. In this case, there is a possibility that the weight cannot be controlled to an appropriate position.

Further, in a case where the position control of the weight is performed by air pressure, the pressure that can be applied is lower than that of control by hydraulic pressure. Therefore, the position control by the air pressure is not suitable for kneading of materials that cause increase in the internal pressure of the mixing room due to generation of volatile components.

### SUMMARY OF THE INVENTION

An object of the present invention is to suppress occurrence of an unintended lifting motion of a weight when the weight is raised in a state where the pressure in the mixing room is high.

An internal mixer according to one aspect of the present invention includes a mixing chamber having a mixing room, a material input portion that is located above the mixing chamber and allows a material to be kneaded formed by a polymer material to pass through, and feeds the material to be kneaded into the mixing room, a pair of mixing rotors rotatably disposed in parallel to each other in the mixing room and configured to knead the material to be kneaded, a weight disposed in the material input portion so as to be capable of pressing the material to be kneaded in the mixing room from above, a hydraulic circuit having a hydraulic cylinder connected to the weight, and a controller that controls the hydraulic circuit to perform a pressing motion of supplying hydraulic oil to the hydraulic cylinder so that the material to be kneaded is pressed by the weight and a motion for suppressing rapid rise of limiting an operation of the hydraulic cylinder so as to suppress an upward moving speed of the weight when the pressing motion is canceled.

### BRIEF DESCRIPTION OF THE DRAWINGS

FIG. 1 is a diagram schematically illustrating an overall configuration of an internal mixer according to a first embodiment;

FIG. 2 is a diagram schematically illustrating an overall configuration of an internal mixer according to a second embodiment; and

FIG. 3 is a diagram schematically illustrating an overall configuration of an internal mixer according to a third embodiment.

### DETAILED DESCRIPTION

In the following, embodiments of the present invention will be described in detail with reference to the drawings.

### First Embodiment

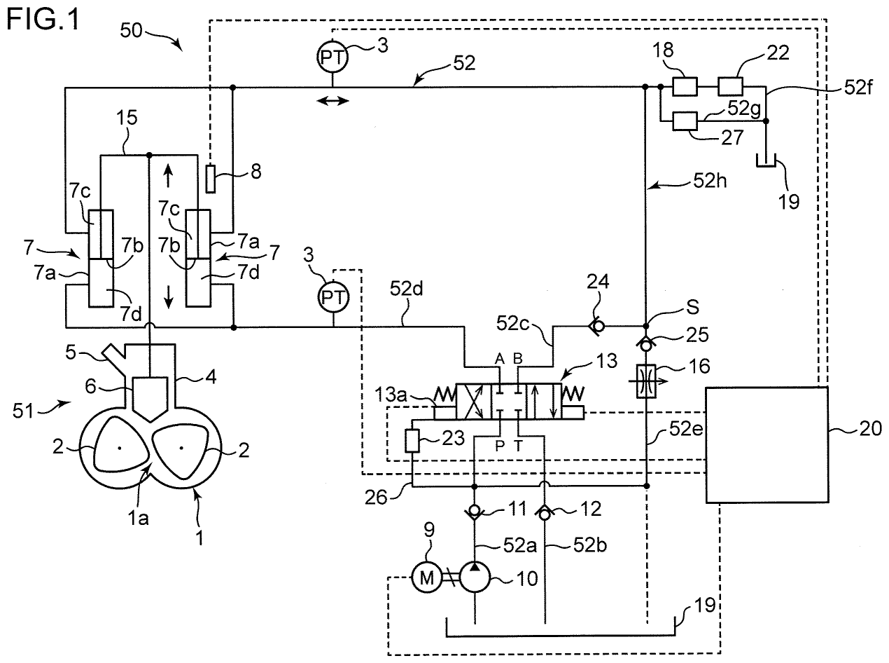

As illustrated in FIG. 1, an internal mixer 50 according to the present embodiment is a device for kneading a material to be kneaded such as rubber or resin, and includes a mixer main body 51, a hydraulic circuit 52 connected to the mixer main body 51, and a controller 20 for controlling the hydraulic circuit 52. The mixer main body 51 includes a mixing chamber 1 having a mixing room 1a, a material input portion 4 located above the mixing chamber 1, a weight 6 disposed in the material input portion 4, and a pair of mixing rotors 2 disposed in the mixing room 1a. The pair of mixing rotors 2 is rotatably disposed in parallel to each other in the mixing room 1a. The pair of mixing rotors 2 is driven to knead the material to be kneaded in the mixing room 1a.

An upper portion of the mixing room 1a is opened. The weight 6 is provided so as to be movable up and down in the material input portion 4, and can be lowered to a position (lower position) entering an upper opening of the mixing room 1a.

The material input portion 4 is provided with a hopper 5. In a state where the weight 6 is at a position (upper position) higher than the hopper 5, the material of the material to be kneaded is fed into the internal space of the material input portion 4 through the hopper 5.

The weight 6 is connected to a hydraulic cylinder 7 provided in the hydraulic circuit 52. The hydraulic cylinder 7 includes a cylinder body 7a and a piston 7b slidably disposed in the cylinder body 7a. The piston 7b is connected to the weight 6 via a connection member 15. Therefore, the weight 6 moves up and down as the piston 7b slides in the cylinder body 7a.

The cylinder body 7a is provided with a position detector 8 for detecting the position of the weight 6 in a vertical direction. The position detector 8 outputs a signal indicating a detected position. This signal is input to the controller 20.

In the cylinder body 7a, a first hydraulic room 7c located on one side with respect to the piston 7b and a second hydraulic room 7d located on the other side with respect to the piston 7b are formed. The first hydraulic room 7c functions as a pressure chamber that generates hydraulic pressure so as to push the weight 6 into the mixing room 1a. Thus, when the weight 6 is raised, the first hydraulic room 7c serves as a hydraulic room that allows hydraulic oil to flow out. The second hydraulic room 7d functions as a pressure chamber that generates hydraulic pressure so as to raise the weight 6 from the mixing room 1a. In other words, the second hydraulic room 7d is a hydraulic room into which the hydraulic oil flows when the weight 6 is raised.

The hydraulic circuit 52 includes a hydraulic servo-valve 13. The hydraulic servo-valve 13 is a switching valve configured to be able to switch the rising, lowering, and stopping of the weight 6. Further, the hydraulic servo-valve 13 has four ports (A port, B port, P port, T port). The hydraulic servo-valve 13 has a pilot port 13a that receives a signal from the controller 20, and adjusts a supply direction and a supply amount of the hydraulic oil based on the received signal.

The hydraulic circuit 52 includes a supply line 52a connected to the P port of the hydraulic servo-valve 13, a discharge line 52b connected to the T port of the hydraulic servo-valve 13, a first hydraulic line 52c connected to the B port of the hydraulic servo-valve 13, and a second hydraulic line 52d connected to the A port of the hydraulic servo-valve 13.

The supply line 52a is provided with a pump 10 that supplies the hydraulic oil from a tank 19 to the hydraulic servo-valve 13, and a check valve 11. The pump 10 is driven by a hydraulic motor 9.

The discharge line 52b is a line for returning the hydraulic oil from the T port of the hydraulic servo-valve 13 to the tank 19. The discharge line 52b is provided with a check valve 12.

The first hydraulic line 52c connects the first hydraulic room 7c and the B port of the hydraulic servo-valve 13 to each other. The first hydraulic line 52c is provided with a check valve 24. The check valve 24 allows the flow of the hydraulic oil from the hydraulic servo-valve 13 toward the first hydraulic room 7c and blocks the flow of the hydraulic oil in the opposite direction.

The second hydraulic line 52d connects the second hydraulic room 7d and the A port of the hydraulic servo-valve 13 to each other. A pressure detector 3 is disposed in each of the first hydraulic line 52c and the second hydraulic line 52d.

The hydraulic servo-valve 13 is a switching valve capable of adjusting the supply direction and the supply amount of the hydraulic oil, and is configured to be able to switch the state among a pressing state, a retracted state, and a stop state. The state of the hydraulic servo-valve 13 is switched on the basis of a signal from the controller 20 to the pilot port 13a.

In the pressing state, the P port is connected to the B port and the A port is connected to the T port. Thus, the hydraulic oil in the supply line 52a is supplied to the first hydraulic room 7c through the first hydraulic line 52c, and the hydraulic oil in the second hydraulic room 7d flows out to the second hydraulic line 52d. Thus, the piston 7b is positioned at a lower position.

In the retracted state, the P port is connected to the A port and the B port is connected to the T port. Thus, the hydraulic oil in the supply line 52a is supplied to the second hydraulic room 7d through the second hydraulic line 52d, and the hydraulic oil in the first hydraulic room 7c flows out to the first hydraulic line 52c. Thus, the piston 7b rises from the lower position.

In the stop state, the flow of the hydraulic oil between the A port and the B port and the P port and the T port is stopped.

The hydraulic circuit 52 further includes a connection line 52e, a branched line 52f, a bypass line 52g, and a pilot line 26.

The connection line 52e is a line that connects the first hydraulic line 52c and the supply line 52a. The connection line 52e has one end portion and the other end portion, the one end portion (also referred to as a connection portion S) being connected to a portion of the first hydraulic line 52c between the check valve 24 and the first hydraulic room 7c, and the other end portion being connected to a portion of the supply line 52a between the pump 10 (or the check valve 11) and the hydraulic servo-valve 13. Note that the other end portion of the connection line 52e may be connected to the tank 19.

The connection line 52e is provided with a flow control valve 16 and a check valve 25. The flow control valve 16 is configured to limit the flow rate of the hydraulic oil flowing through the connection line 52e to a predetermined value or less. The check valve 25 allows the flow of the hydraulic oil flowing from the first hydraulic line 52c into the connection line 52e and blocks the flow of the hydraulic oil in the opposite direction. In other words, the check valve 25 allows the flow of the hydraulic oil in the direction returning from the first hydraulic room 7c to the hydraulic servo-valve 13, and blocks the flow of the hydraulic oil in the opposite direction.

The section of the first hydraulic line 52c from the first hydraulic room 7c to the connection portion S of the connection line 52e and the connection line 52e constitute a return line 52h for returning the hydraulic oil flowing out of the first hydraulic room 7c to the hydraulic servo-valve 13 when the weight 6 is raised.

The branched line 52f is connected to a portion of the first hydraulic line 52c between the first hydraulic room 7c and the connection portion S of the connection line 52e. Further, the branched line 52f is connected to the tank 19. The branched line 52f is provided with a shut-off valve 18 and a relief valve 22.

The shut-off valve 18 is configured to open the branched line 52f when receiving a signal from the controller 20, and to shut off the branched line 52f when the reception of the signal is stopped. That is, during normal operation, the shut-off valve 18 continuously receives the signal from the controller 20, and thus the branched line 52f is in an open state.

The relief valve 22 is configured to release the pressure when the pressure in the branched line 52f exceeds a predetermined value. Note that the relief valve 22 may be a proportional relief valve capable of changing a set value of the operation pressure in accordance with a command from the controller 20.

A bypass line 52g is connected to the branched line 52f so as to bypass the shut-off valve 18 and is connected to the tank 19. The bypass line 52g is provided with a relief valve 27. The relief valve 27 is configured to release pressure when the pressure in the first hydraulic line 52c (or the bypass line 52g) exceeds a predetermined value while the shut-off valve 18 is in a shut-off state. Note that the relief valve 27 may be a proportional relief valve capable of changing a set value of the operation pressure in accordance with a command from the controller 20.

The pilot line 26 connects the supply line 52a and the pilot port 13a of the hydraulic servo-valve 13 to each other. The pilot line 26 is provided with a shut-off valve 23. The shut-off valve 23 is configured to open the pilot line 26 when receiving a signal from the controller 20, and to shut off the pilot line 26 when the reception of the signal is stopped. When the pilot line 26 is shut off, the hydraulic pressure supply to the pilot port 13a is stopped, so that the hydraulic servo-valve 13 returns to the stop state. Note that, during normal operation, the shut-off valve 23 continuously receives a signal from the controller 20, and thus the pilot line 26 is in an open state.

The controller 20 is constituted of a microcomputer including a CPU that performs arithmetic processing, a ROM that stores a processing program, data, and the like, and a RAM that temporarily stores data. The controller 20 executes the processing program to control the hydraulic servo-valve 13 so that a pressing motion and a motion for suppressing rapid rise are performed. That is, the controller 20 includes a pressing motion execution unit and a motion for suppressing rapid rise execution unit as functions thereof. The pressing motion execution unit executes a control operation for executing the pressing motion, and the motion for suppressing rapid rise execution unit executes a control operation for executing the motion for suppressing rapid rise.

In the pressing motion, the hydraulic oil is supplied to the first hydraulic room 7c of the hydraulic cylinder 7 so that the weight 6 is located at a position (lower position) entering the upper opening of the mixing room 1a and the material to be kneaded in the mixing room 1a is pressed by the weight 6. In this case, the controller 20 drives the hydraulic motor 9 so that the pump 10 operates, and switches the hydraulic servo-valve 13 to the pressing state.

The motion for suppressing rapid rise is performed when the pressing motion is canceled. The pressing motion is canceled, for example, when the controller 20 receives a command to raise the weight 6 from the lower position, when power is lost, when the controller 20 receives an emergency stop command, or when the controller 20 receives a failure signal of a hydraulic device such as a hydraulic motor or a hydraulic pipe.

When the controller 20 receives a command to raise the weight 6 from the lower position, the controller 20 switches the hydraulic servo-valve 13 to the retracted state. At this time, the controller 20 controls the hydraulic servo-valve 13 based on a detected position signal by the position detector 8. That is, the controller 20 calculates the moving speed of the weight 6 from the temporal change of the position of the weight 6 detected by the position detector 8, and controls the hydraulic servo-valve 13 so that the upward moving speed of the weight 6 becomes substantially constant. Thus, even if the weight 6 is raised in a state where the pressure in the mixing room 1a is high, the sudden rise of the weight 6 can be suppressed.

Further, when the hydraulic servo-valve 13 is switched to the retracted state, the hydraulic oil in the supply line 52a is supplied to the second hydraulic room 7d through the second hydraulic line 52d, and the hydraulic oil in the first hydraulic room 7c flows out to the first hydraulic line 52c. Since the check valve 24 is provided in the first hydraulic line 52c, the hydraulic oil in the first hydraulic line 52c flows into the connection line 52e. Therefore, the flow control valve 16 limits the flow rate of the hydraulic oil flowing through the first hydraulic line 52c to a predetermined value or less. This hydraulic oil flows into the supply line 52a. That is, the hydraulic servo-valve 13 is controlled so that the upward moving speed of the weight 6 is substantially constant, and the flow control valve 16 limits the flow rate of the hydraulic oil.

Further, when power is lost, transmission of signals from the controller 20 to the shut-off valve 18 and the shut-off valve 23 is stopped. Therefore, when the power is lost, the branched line 52f is shut off by the shut-off valve 18, and the pilot line 26 is shut off by the shut-off valve 23. The hydraulic servo-valve 13 returns to the stop state due to the interruption of the pilot line 26. Therefore, the hydraulic oil between the first hydraulic room 7c and the tank 19 and between the first hydraulic room 7c and the P port of the hydraulic servo-valve 13 is held without flowing. Thus, when power loss occurs while the weight 6 rises, the rising of the weight 6 stops. In other words, the sudden rise of the weight 6 is further suppressed.

Further, for example, in a case where the power is lost when the weight 6 is held at the lower position, similarly, the hydraulic oil between the first hydraulic room 7c and the tank 19 and between the first hydraulic room 7c and the P port of the hydraulic servo-valve 13 is held as it is. Therefore, the power loss prevents the sudden rise of the weight 6 due to the internal pressure of the mixing room 1a.

Further, when the controller 20 receives the emergency stop command, transmission of signals from the controller 20 to the shut-off valve 18 and the shut-off valve 23 is stopped. Therefore, also in this case, the branched line 52f is shut off by the shut-off valve 18, and the pilot line 26 is shut off by the shut-off valve 23. The hydraulic servo-valve 13 returns to the stop state due to the interruption of the pilot line 26. Therefore, the hydraulic oil between the first hydraulic room 7c and the tank 19 and between the first hydraulic room 7c and the P port of the hydraulic servo-valve 13 is held. Thus, when the controller 20 receives the emergency stop command while the weight 6 rises, the rising of the weight 6 stops. In other words, the sudden rise of the weight 6 is suppressed.

As described above, in the internal mixer 50 according to the present embodiment, the controller 20 controls the hydraulic circuit 52 to perform the pressing motion when kneading the material to be kneaded. In this pressing motion, hydraulic oil is supplied to the hydraulic cylinder 7 so that the material to be kneaded is pressed by the weight 6, and a pressing force is applied to the weight 6 by the hydraulic cylinder 7. Further, the controller 20 controls the hydraulic circuit 52 so that the motion for suppressing rapid rise is performed when the pressing motion is canceled. In this motion for suppressing rapid rise, the operation of the hydraulic cylinder 7 is limited so that the upward moving speed of the weight 6 is suppressed. Therefore, even if the pressing motion is canceled in a state in which volatile components such as moisture are generated from the material to be kneaded and the pressure in the mixing room 1a is high, the sudden rise of the weight 6 by receiving the high pressure in the mixing room 1a can be prevented. That is, it is possible to suppress the occurrence of an unintended rising motion of the weight 6.

Further, in the present embodiment, the hydraulic servo-valve 13 is controlled so that the moving speed of the weight 6 becomes substantially constant in the motion for suppressing rapid rise. Thus, even if the pressing motion is canceled in a state where volatile components such as moisture are generated from the material to be kneaded and the pressure in the mixing room 1a is high, the sudden rise of the weight 6 can be prevented. In addition, since the operation control by the hydraulic servo-valve 13 is performed, the weight 6 can be smoothly operated.

Further, in the present embodiment, in the motion for suppressing rapid rise, the flow rate of the hydraulic oil flowing out of the first hydraulic room 7c of the hydraulic cylinder 7 is limited to a predetermined value or less by the flow control valve 16. Thus, even if the pressing motion is canceled in a state in which volatile components such as moisture are generated from the material to be kneaded and the pressure in the mixing room 1a is high, the sudden rise of the weight 6 by receiving the high pressure in the mixing room 1a can be prevented. That is, the hydraulic servo-valve 13 is controlled so that the upward moving speed of the weight 6 is substantially constant, and the flow control valve 16 limits the flow rate of the hydraulic oil. Therefore, the sudden rise of the weight 6 can be more reliably suppressed. Moreover, since the flow rate is limited by a mechanical mechanism such as an internal throttle, the sudden rise of the weight 6 can be more reliably suppressed.

Further, in the present embodiment, in the motion for suppressing rapid rise at the time of emergency stop or the like, the flow of the hydraulic oil in the branched line 52f is shut off by the shut-off valve 18, and the flow of the hydraulic oil in the first hydraulic line 52c is stopped by the control of the hydraulic servo-valve 13. Thus, the sudden rise of the weight 6 is stopped, so that it is possible to suppress the occurrence of an unintended rising motion of the weight 6. Further, since the shut-off valve 18 is provided in the branched line 52f, it is not necessary to provide unnecessary equipment in the first hydraulic line 52c. In addition, in the case of kneading a normal material to be kneaded, it is also possible to cope with the case by not using a hydraulic device ahead of the branched line 52f.

Further, in the present embodiment, the bypass line 52g that bypasses the shut-off valve 18 is provided in the branched line 52f provided with the relief valve 22, and the relief valve 27 is provided in the bypass line 52g. Therefore, even when the shut-off valve 18 functions to shut off the relief valve 22 from the first hydraulic line 52c (or the return line 52h), the relief valve 27 can prevent the pressure of the first hydraulic line 52c (or the return line 52h) from rising to a pressure higher than expected.

Further, in the present embodiment, in the motion for suppressing rapid rise, when the shut-off valve 23 operates, the hydraulic servo-valve 13 returns to the stop state. In this case, it is possible to reliably prevent the sudden rise of the weight 6 by stopping the supply of the hydraulic oil from the hydraulic servo-valve 13 in addition to the suppression of the sudden rise by constant speed control of the weight 6 upward. In addition, it is also possible to prevent hydraulic leakage of hydraulic oil in a pilot circuit portion of the hydraulic servo-valve 13.

Further, in the present embodiment, the rising speed of the weight 6 can be limited by the flow control valve 16 even in a case where the sudden rise of the weight 6 cannot be prevented only by controlling the rising speed of the weight 6 to be substantially constant by the hydraulic servo-valve 13. Furthermore, since the sudden rise of the weight 6 is prevented by the shut-off valve 18 and the shut-off valve 23, the sudden rise of the weight 6 can be more reliably prevented.

Note that, in the present embodiment, since the sudden rise of the weight 6 by the hydraulic servo-valve 13 is suppressed and the flow control valve 16 is also provided, the shut-off valve 23 of the pilot line 26 can be omitted.

Further, in the present embodiment, since the sudden rise of the weight 6 by the hydraulic servo-valve 13 is suppressed and the flow control valve 16 is also provided, the shut-off valve 18 disposed in the branched line 52f may be omitted. In this case, the bypass line 52g including the relief valve 27 is also omitted.

Further, in the present embodiment, since the moving speed of the piston 7b (weight 6) is controlled by controlling the hydraulic servo-valve 13 on the basis of the detected position of the position detector 8, the flow control valve 16 can be omitted. However, the sudden rise can be more reliably suppressed by the flow control valve 16.

Further, in the present embodiment, when the weight 6 is raised, the hydraulic servo-valve 13 is controlled so that the moving speed of the weight 6 becomes substantially constant on the basis of the detected position of the position detector 8, but this control may be omitted. In this case, the upward moving speed of the weight 6 by the flow control valve 16 is suppressed.

Further, in the present embodiment, the pressure in the first hydraulic line 52c can be detected by the pressure detector 3 provided in the first hydraulic line 52c. Therefore, the position control by the position detector 8 is not always performed when the weight 6 is raised, but the constant speed control of the weight 6 based on the position detected by the position detector 8 may be performed only when the pressure detected by the pressure detector 3 of the first hydraulic line 52c exceeds a predetermined pressure. In this case, when the pressure detected by the pressure detector 3 of the first hydraulic line 52c is equal to or lower than the predetermined pressure, the weight 6 can be raised without referring to a value detected by the position detector 8.

### Second Embodiment

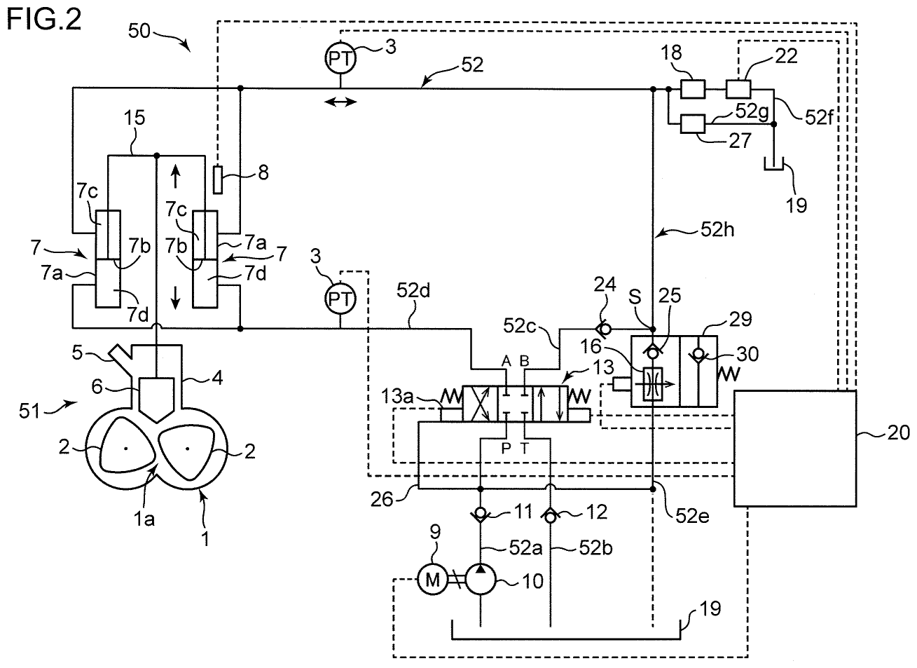

As illustrated in FIG. 2, the internal mixer 50 according to the second embodiment includes a flow control mechanism 29 disposed in the connection line 52e, while the shut-off valve 23 of the pilot line 26 is omitted. Note that, here, the same components as those of the first embodiment are denoted by the same reference numerals, and detailed descriptions thereof will be omitted.

The flow control mechanism 29 includes a flow control valve 16 and a shut-off valve 30. The flow control mechanism 29 is configured to be able to switch the flowing state of the hydraulic oil in the connection line 52e between a flow limiting state in which the flow control valve 16 functions and a flow shut-off state in which the shut-off valve 30 functions. The flow control mechanism 29 is switched to the flow limiting state or the flow shut-off state in accordance with a command from the controller 20.

When the controller 20 receives a command to raise the weight 6 from the lower position, the controller 20 switches the hydraulic servo-valve 13 to the retracted state and switches the flow control mechanism 29 to the flow limiting state. Thus, the flow control mechanism 29 limits the flow rate of the hydraulic oil flowing out of the first hydraulic room 7c and flowing through the return line 52h. Therefore, even if the pressure in the mixing room 1a is increased, the sudden rise of the weight 6 can be suppressed.

When the power is lost or the controller 20 receives an emergency stop command, the controller 20 switches the hydraulic servo-valve 13 to the stop state and switches the flow control mechanism 29 to the flow shut-off state. Further, at this time, the shut-off valve 18 of the branched line 52f is also shut off. Thus, the outflow of the hydraulic oil from the first hydraulic room 7c is shut off, so that the piston 7b of the hydraulic cylinder 7 stops. Thus, even if the pressure in the mixing room 1a is increased, the sudden rise of the weight 6 can be suppressed.

Note that, in the present embodiment, the branched line 52f and the bypass line 52g can be omitted.

Further, in the present embodiment, when raising the weight 6, the controller 20 controls the hydraulic servo-valve 13 so that the moving speed of the weight 6 becomes substantially constant on the basis of the detected position of the position detector 8. However, this control can be omitted.

Further, in the present embodiment, it is not necessary to always perform the position control by the position detector 8 when the weight 6 is raised. That is, the controller 20 may perform the constant speed control of the weight 6 based on the position detected by the position detector 8 only when the pressure detected by the pressure detector 3 of the first hydraulic line 52c exceeds a predetermined pressure.

Although other configurations, operations, and effects are not described, the description of the first embodiment can be applied to the second embodiment.

### Third Embodiment

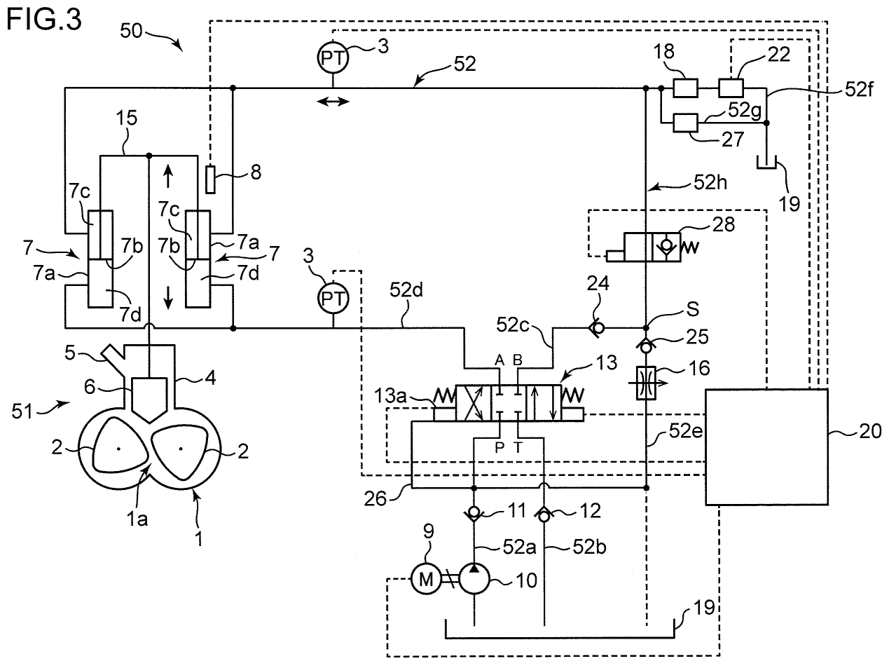

As illustrated in FIG. 3, in the third embodiment, instead of the shut-off valve 23 disposed in the pilot line 26, a shut-off valve 28 disposed in the first hydraulic line 52c is provided. Note that, here, the same components as those of the first and second embodiments are denoted by the same reference numerals, and detailed descriptions thereof will be omitted.

The shut-off valve 28 is disposed in the first hydraulic line 52c between the first hydraulic room 7c and a connection portion S of the connection line 52e. The shut-off valve 28 is configured to open the first hydraulic line 52c when receiving a signal from the controller 20, and to shut off the first hydraulic line 52c when receiving the signal is stopped. That is, since the shut-off valve 28 continuously receives a signal from the controller 20 during normal operation, the first hydraulic line 52c is in an open state. On the other hand, when the power is lost, transmission of signals from the controller 20 to the shut-off valve 28 is stopped, and thus the shut-off valve 28 shuts off the first hydraulic line 52c. At this time, the shut-off valve 18 of the branched line 52f is also shut off.

Further, when the controller 20 receives the emergency stop command, transmission of signals from the controller 20 to the shut-off valve 18 and the shut-off valve 28 is stopped. Therefore, also in this case, the branched line 52f is shut off by the shut-off valve 18, and the first hydraulic line 52c is shut off by the shut-off valve 28.

Therefore, in the present embodiment, in the motion for suppressing rapid rise at the time of emergency stop or the like, the flow of the hydraulic oil in the branched line 52f is shut off by the shut-off valve 18, and the flow of the hydraulic oil in the first hydraulic line 52c is stopped by the shut-off valve 28. Thus, the sudden rise of the weight 6 is stopped, so that it is possible to suppress the occurrence of an unintended rising motion of the weight 6.

Note that, in the present embodiment, the branched line 52f and the bypass line 52g can be omitted. Further, in the present embodiment, the flow control valve 16 can be omitted. Further, in the present embodiment, when raising the weight 6, the controller 20 controls the hydraulic servo-valve 13 so that the moving speed of the weight 6 becomes substantially constant on the basis of the detected position of the position detector 8. However, this control can be omitted. Further, in the present embodiment, it is not necessary to always perform the position control by the position detector 8 when the weight 6 is raised. That is, the constant speed control of the weight 6 based on the position detected by the position detector 8 may be performed only when the pressure detected by the pressure detector 3 of the first hydraulic line 52c exceeds a predetermined pressure.

Although other configurations, operations, and effects are not described, the description of the first embodiment can be applied to the second embodiment.

### Other Embodiments

Note that it should be understood that the embodiment disclosed herein is illustrative in all respects and are not restrictive. The present invention is not limited to the above embodiment, and various changes, improvements, and the like can be made without departing from the gist of the present invention.

Here, the embodiments will be outlined.

An internal mixer according to the embodiment includes a mixing chamber having a mixing room, a material input portion that is located above the mixing chamber and allows a material to be kneaded formed by a polymer material to pass through, and feeds the material to be kneaded into the mixing room, a pair of mixing rotors rotatably disposed in parallel to each other in the mixing room and configured to knead the material to be kneaded, a weight disposed in the material input portion so as to be capable of pressing the material to be kneaded in the mixing room from above, a hydraulic circuit having a hydraulic cylinder connected to the weight, and a controller that controls the hydraulic circuit to perform a pressing motion of supplying hydraulic oil to the hydraulic cylinder so that the material to be kneaded is pressed by the weight and a motion for suppressing rapid rise of limiting an operation of the hydraulic cylinder so as to suppress an upward moving speed of the weight when the pressing motion is canceled.

In the internal mixer, the controller controls the hydraulic circuit to perform a pressing motion when kneading the material to be kneaded. In this pressing motion, hydraulic oil is supplied to the hydraulic cylinder so that the material to be kneaded is pressed by the weight, and a pressing force is applied to the weight by the hydraulic cylinder. Further, the controller controls the hydraulic circuit so that the motion for suppressing rapid rise is performed when the pressing motion is canceled. In the motion for suppressing rapid rise, the operation of the hydraulic cylinder is controlled so that the upward moving speed of the weight is suppressed. Therefore, even if the pressing motion is canceled in a state in which volatile components such as moisture are generated from the material to be kneaded and the pressure in the mixing room is high, the sudden rise of the weight by receiving the high pressure in the mixing room can be prevented. That is, it is possible to suppress the occurrence of an unintended lifting operation of the weight.

The internal mixer may further include a position detector for detecting a position of the weight in a vertical direction. The hydraulic circuit may include a hydraulic servo-valve capable of adjusting a supply direction and a supply amount of hydraulic oil to the hydraulic cylinder. In this case, the controller may be configured to calculate a moving speed of the weight from a temporal change in the position of the weight detected by the position detector and control the hydraulic servo-valve so that the upward moving speed of the weight becomes substantially constant in the motion for suppressing rapid rise.

In this aspect, in the motion for suppressing rapid rise, the hydraulic servo-valve is controlled so that the moving speed of the weight becomes substantially constant. Therefore, even if the pressing motion is canceled in a state in which volatile components such as moisture are generated from the material to be kneaded and the pressure in the mixing room is high, a sudden rise of the weight can be prevented. Further, since the operation control by the hydraulic servo-valve is performed, the weight can be smoothly operated.

The hydraulic cylinder may include a first hydraulic room into which hydraulic oil flows when the weight is lowered, and a second hydraulic room into which hydraulic oil flows when the weight is raised. The hydraulic circuit may include a hydraulic servo-valve configured to be capable of switching a supply direction of hydraulic oil to the first hydraulic room or the second hydraulic room, and a flow control valve that limits a flow rate of hydraulic oil flowing out of the first hydraulic room to a predetermined value or less. In this case, the controller may be configured to control the hydraulic servo-valve so that hydraulic oil flows to the flow control valve in the motion for suppressing rapid rise.

In this aspect, in the motion for suppressing rapid rise, the flow rate of the hydraulic oil flowing out of the first hydraulic room of the hydraulic cylinder is limited to a predetermined value or less by the flow control valve. Thus, even if the pressing motion is canceled in a state in which volatile components such as moisture are generated from the material to be kneaded and the pressure in the mixing room is high, the sudden rise of the weight by receiving the high pressure in the mixing room can be prevented. Moreover, since the flow rate is limited by a mechanical mechanism called an internal throttle, it is possible to more reliably suppress the sudden rise of the weight even when position control by a servo mechanism is not performed.

The hydraulic cylinder may include a first hydraulic room into which hydraulic oil flows when the weight is lowered, and a second hydraulic room into which hydraulic oil flows when the weight is raised. The hydraulic circuit may include a return line through which hydraulic oil flowing out of the first hydraulic room flows, and a flow control mechanism provided in the return line. The flow control mechanism may include a flow control valve that limits a flow rate of the hydraulic oil flowing out of the first hydraulic room to be equal to or less than a predetermined value, and a shut-off valve that shuts off flowing out of the hydraulic oil from the first hydraulic room. In this case, the controller may control the flow control mechanism so as to cause the flow control valve of the flow control mechanism to function when the pressing motion is canceled by a command for raising the weight, and to cause the shut-off valve of the flow control mechanism to function when the pressing motion is canceled by power loss or an emergency stop command.

In this aspect, the flow control mechanism functions as the flow control valve when the pressing motion is canceled by a command for raising the weight, and the flow control mechanism functions as a shut-off valve when power is lost or when an emergency stop command is received. Therefore, in any case where the pressing motion is canceled, the upward moving speed of the weight is suppressed. Thus, even if the pressing motion is canceled in a state in which volatile components such as moisture are generated from the material to be kneaded and the pressure in the mixing room is high, the sudden rise of the weight by receiving the high pressure in the mixing room can be prevented.

The hydraulic cylinder may include a first hydraulic room into which hydraulic oil flows when the weight is lowered, and a second hydraulic room into which hydraulic oil flows when the weight is raised. The hydraulic circuit may include a return line through which hydraulic oil flowing out of the first hydraulic room flows, and a shut-off valve provided in the return line. In this case, the controller may control the shut-off valve so that the flow of the hydraulic oil in the return line is shut off in the motion for suppressing rapid rise.

In this aspect, in the motion for suppressing rapid rise, the flow of the hydraulic oil in the return line is shut off by the shut-off valve. Thus, the sudden rise of the weight is stopped, so that it is possible to suppress the occurrence of an unintended rising motion of the weight. Moreover, since the shut-off valve can be operated instantaneously in a short time, it is possible to more reliably prevent the sudden rise of the weight.

The hydraulic cylinder may include a first hydraulic room into which hydraulic oil flows when the weight is lowered, and a second hydraulic room into which hydraulic oil flows when the weight is raised. The hydraulic circuit may include a hydraulic servo-valve configured to be capable of switching a supply direction of hydraulic oil to the first hydraulic room or the second hydraulic room, a return line that returns hydraulic oil flowing out of the first hydraulic room to the hydraulic servo-valve, and a shut-off valve provided in a branched line branching from the return line. In this case, the controller, in the motion for suppressing rapid rise, may control the hydraulic servo-valve so that flow of the hydraulic oil in the return line is stopped, and control the shut-off valve so that flow of hydraulic oil in the branched line is shut off.

In this aspect, in the motion for suppressing rapid rise, the flow of the hydraulic oil in the branched line is shut off by the shut-off valve, and the flow of the hydraulic oil in the first hydraulic line is stopped by the control of the hydraulic servo-valve. Thus, the sudden rise of the weight is stopped, so that it is possible to suppress the occurrence of an unintended rising motion of the weight. Further, since the shut-off valve is provided in the branched line, it is not necessary to provide an unnecessary device in the first hydraulic line. In addition, in the case of kneading a normal material to be kneaded, it is also possible to cope with the case by not using a hydraulic device ahead of the branched line.

The internal mixer may further include a relief valve provided in a bypass line connected to the branched line so as to bypass the shut-off valve.

In this aspect, when the branched line is shut off by the shut-off valve, it is possible to prevent the pressure of the return line from rising to a pressure higher than expected. Further, in a case where the weight is pushed up by the material to be kneaded, or the like, pressure accuracy can be improved, or the return line can be prevented from being damaged.

The hydraulic circuit may further include a shut-off valve disposed in a pilot line of the hydraulic servo-valve. In this case, the controller may be configured to control the shut-off valve so that flow of hydraulic oil in the pilot line is shut off in the motion for suppressing rapid rise. Further, the hydraulic servo-valve may be configured to switch to a stop state in which supply of the hydraulic oil from the hydraulic servo-valve is stopped by stopping of supply of the hydraulic oil to the pilot line.

In this aspect, the shut-off valve of the pilot line operates in the motion for suppressing rapid rise. Therefore, in addition to the suppression of the sudden rise by the flow control valve, the sudden rise of the weight can be reliably prevented by stopping the supply of the hydraulic oil from the hydraulic servo-valve. In addition, it is also possible to prevent hydraulic leakage of hydraulic oil in a pilot circuit portion of the hydraulic servo-valve.

The controller may be configured to cause the shut-off valve to function when the pressing motion is canceled due to power loss. In this aspect, it is possible to prevent the sudden rise of the weight even in an abnormal situation such as power loss.

The controller may be configured to cause the shut-off valve to function when the pressing motion is canceled by receiving an emergency stop command. In this aspect, it is possible to prevent the sudden rise of the weight at the time of emergency stop.

The internal mixer may further include a position detector for detecting a position of the weight in a vertical direction. In this case, the hydraulic cylinder may include a first hydraulic room into which hydraulic oil flows when the weight is lowered, and a second hydraulic room into which hydraulic oil flows when the weight is raised. Further, the hydraulic circuit may include a hydraulic servo-valve capable of adjusting a supply direction and a supply amount of the hydraulic oil to the first hydraulic room or the second hydraulic room, a flow control valve that limits a flow rate of the hydraulic oil in a return line through which the hydraulic oil flowing out of the first hydraulic room flows to be equal to or less than a predetermined value, and a shut-off valve provided in the return line. In this case, the controller may be configured to, in the motion for suppressing rapid rise, calculate a moving speed of the weight from a temporal change of the position of the weight detected by the position detector, and control the hydraulic servo-valve so that the upward moving speed of the weight becomes substantially constant and the hydraulic oil flows to the return line, and control the shut-off valve to shut off flow of the hydraulic oil in the return line.

In this aspect, it is possible to more reliably prevent the sudden rise of the weight when the pressing motion is canceled. That is, the rising speed of the weight can be limited by the flow control valve even in a case where the sudden rise of the weight cannot be prevented only by controlling the rising speed of the weight to be substantially constant by the hydraulic servo-valve. Furthermore, since the sudden rise of the weight is also prevented by the shut-off valve, the sudden rise of the weight can be more reliably prevented.

The internal mixer may further include a position detector for detecting a position of the weight in a vertical direction. In this case, the hydraulic cylinder may include a first hydraulic room into which hydraulic oil flows when the weight is lowered, and a second hydraulic room into which hydraulic oil flows when the weight is raised. Further, the hydraulic circuit may include a hydraulic servo-valve configured to be capable of switching a supply direction of hydraulic oil to the first hydraulic room or the second hydraulic room, a return line that returns hydraulic oil flowing out of the first hydraulic room to the hydraulic servo-valve, a flow control valve that limits a flow rate of the hydraulic oil flowing through the return line to be equal to or less than a predetermined value, and a shut-off valve provided in a branched line branching from the return line. In this case, the controller may be configured to, in the motion for suppressing rapid rise, control the hydraulic servo-valve so that the hydraulic oil flows out of the first hydraulic room, a moving speed of the weight is calculated from a temporal change of the position of the weight detected by the position detector, the upward moving speed of the weight becomes substantially constant, and the hydraulic oil flows to the return line, and control the shut-off valve to shut off flow of the hydraulic oil in the branched line.

In this aspect, it is possible to more reliably prevent the sudden rise of the weight when the pressing motion is canceled. That is, the rising speed of the weight can be limited by the flow control valve even in a case where the sudden rise of the weight cannot be prevented only by controlling the rising speed of the weight to be substantially constant by the hydraulic servo-valve. Furthermore, since the sudden rise of the weight is also prevented by the shut-off valve, the sudden rise of the weight can be more reliably prevented.

The internal mixer may further include a position detector for detecting a position of the weight in a vertical direction. In this case, the hydraulic cylinder may include a first hydraulic room into which hydraulic oil flows when the weight is lowered, and a second hydraulic room into which hydraulic oil flows when the weight is raised. Further, the hydraulic circuit may include a hydraulic servo-valve configured to be capable of switching a supply direction of hydraulic oil to the first hydraulic room or the second hydraulic room, a return line that returns hydraulic oil flowing out of the first hydraulic room to the hydraulic servo-valve, a flow control valve that limits a flow rate of the hydraulic oil flowing through the return line to be equal to or less than a predetermined value, and a shut-off valve disposed in a pilot line of the hydraulic servo-valve. In this case, the controller may be configured to, in the motion for suppressing rapid rise, control the hydraulic servo-valve so that the hydraulic oil flows out of the first hydraulic room, a moving speed of the weight is calculated from a temporal change of the position of the weight detected by the position detector, the upward moving speed of the weight becomes substantially constant, and the hydraulic oil flows to the return line, and control the shut-off valve to shut off flow of the hydraulic oil in the pilot line.

In this aspect, it is possible to more reliably prevent the sudden rise of the weight when the pressing motion is canceled. That is, the rising speed of the weight can be limited by the flow control valve even in a case where the sudden rise of the weight cannot be prevented only by controlling the rising speed of the weight to be substantially constant by the hydraulic servo-valve. Furthermore, since the sudden rise of the weight is also prevented by the shut-off valve, the sudden rise of the weight can be more reliably prevented.

As described above, it is possible to suppress occurrence of an unintended lifting operation of a weight when the weight is raised in a state where the pressure in the mixing room is high.

This application is based on U.S. Provisional application No. 63/707451 filed in United States Patent and Trademark Office on October. 15, 2024, the contents of which are hereby incorporated by reference.

1. An internal mixer comprising:
a mixing chamber having a mixing room;
a material input portion that is located above the mixing chamber and allows a material to be kneaded formed by a polymer material to pass through and feed the material to be kneaded into the mixing room;
a pair of mixing rotors rotatably disposed in parallel to each other in the mixing room and configured to knead the material to be kneaded;
a weight disposed in the material input portion so as to be capable of pressing the material to be kneaded in the mixing room from above;
a hydraulic circuit having a hydraulic cylinder connected to the weight; and
a controller that controls the hydraulic circuit to perform a pressing motion of supplying hydraulic oil to the hydraulic cylinder so that the material to be kneaded is pressed by the weight and a motion for suppressing rapid rise of limiting an operation of the hydraulic cylinder so as to suppress an upward moving speed of the weight when the pressing motion is canceled.

2. The internal mixer according to claim 1, further comprising:
a position detector for detecting a position of the weight in a vertical direction,
the hydraulic circuit includes a hydraulic servo-valve capable of adjusting a supply direction and a supply amount of hydraulic oil to the hydraulic cylinder, wherein
the controller is configured to calculate a moving speed of the weight from a temporal change in the position of the weight detected by the position detector and control the hydraulic servo-valve so that the upward moving speed of the weight becomes substantially constant in the motion for suppressing rapid rise.

3. The internal mixer according to claim 1, wherein
the hydraulic cylinder includes a first hydraulic room into which hydraulic oil flows when the weight is lowered, and a second hydraulic room into which hydraulic oil flows when the weight is raised, and
the hydraulic circuit includes a hydraulic servo-valve configured to be capable of switching a supply direction of hydraulic oil to the first hydraulic room or the second hydraulic room, and a flow control valve that limits a flow rate of hydraulic oil flowing out of the first hydraulic room to a predetermined value or less, and
the controller is configured to control the hydraulic servo-valve so that hydraulic oil flows to the flow control valve in the motion for suppressing rapid rise.

4. The internal mixer according to claim 1, wherein
the hydraulic cylinder includes a first hydraulic room into which hydraulic oil flows when the weight is lowered, and a second hydraulic room into which hydraulic oil flows when the weight is raised,
the hydraulic circuit includes a hydraulic servo-valve configured to be capable of switching a supply direction of hydraulic oil to the first hydraulic room or the second hydraulic room, a return line through which hydraulic oil flowing out of the first hydraulic room flows, and a flow control mechanism provided in the return line,
the flow control mechanism includes a flow control valve that limits a flow rate of the hydraulic oil flowing out of the first hydraulic room to be equal to or less than a predetermined value, and a shut-off valve that shuts off flowing out of the hydraulic oil from the first hydraulic room, and
the controller controls the flow control mechanism so as to cause the flow control valve of the flow control mechanism to function when the pressing motion is canceled by a command for raising the weight, and to cause the shut-off valve of the flow control mechanism to function when the pressing motion is canceled by power loss or an emergency stop command.

5. The internal mixer according to claim 1, wherein
the hydraulic cylinder includes a first hydraulic room into which hydraulic oil flows when the weight is lowered, and a second hydraulic room into which hydraulic oil flows when the weight is raised,
the hydraulic circuit includes a return line through which hydraulic oil flowing out of the first hydraulic room flows, and a shut-off valve provided in the return line, and
the controller controls the shut-off valve so as to shut off flow of the hydraulic oil in the return line in the motion for suppressing rapid rise.

6. The internal mixer according to claim 1, wherein
the hydraulic cylinder includes a first hydraulic room into which hydraulic oil flows when the weight is lowered, and a second hydraulic room into which hydraulic oil flows when the weight is raised,
the hydraulic circuit includes a hydraulic servo-valve configured to be capable of switching a supply direction of hydraulic oil to the first hydraulic room or the second hydraulic room, a return line that returns hydraulic oil flowing out of the first hydraulic room to the hydraulic servo-valve, and a shut-off valve provided in a branched line branching from the return line, and
the controller, in the motion for suppressing rapid rise, controls the hydraulic servo-valve so that flow of the hydraulic oil in the return line is stopped, and controls the shut-off valve so that flow of hydraulic oil in the branched line is shut off.

7. The internal mixer according to claim 6, further comprising:
a relief valve provided in a bypass line connected to the branched line so as to bypass the shut-off valve.

8. The internal mixer according to claim 3, wherein
the hydraulic circuit further includes a shut-off valve disposed in a pilot line of the hydraulic servo-valve,
the controller is configured to control the shut-off valve so that flow of hydraulic oil in the pilot line is shut off in the motion for suppressing rapid rise, and
the hydraulic servo-valve is configured to switch to a stop state in which supply of the hydraulic oil from the hydraulic servo-valve is stopped by stopping of supply of the hydraulic oil to the pilot line.

9. The internal mixer according to claim 4, wherein
the hydraulic circuit further includes a shut-off valve disposed in a pilot line of the hydraulic servo-valve,
the controller is configured to control the shut-off valve so that flow of hydraulic oil in the pilot line is shut off in the motion for suppressing rapid rise, and
the hydraulic servo-valve is configured to switch to a stop state in which supply of the hydraulic oil from the hydraulic servo-valve is stopped by stopping of supply of the hydraulic oil to the pilot line.

10. The internal mixer according to claim 6, wherein
the hydraulic circuit further includes a shut-off valve disposed in a pilot line of the hydraulic servo-valve,
the controller is configured to control the shut-off valve so that flow of hydraulic oil in the pilot line is shut off in the motion for suppressing rapid rise, and
the hydraulic servo-valve is configured to switch to a stop state in which supply of the hydraulic oil from the hydraulic servo-valve is stopped by stopping of supply of the hydraulic oil to the pilot line.

11. The internal mixer according to claim 4, wherein the controller is configured to cause the shut-off valve to function when the pressing motion is canceled due to power loss.

12. The internal mixer according to claim 5, wherein the controller is configured to cause the shut-off valve to function when the pressing motion is canceled due to power loss.

13. The internal mixer according to claim 6, wherein the controller is configured to cause the shut-off valve to function when the pressing motion is canceled due to power loss.

14. The internal mixer according to claim 4, wherein the controller is configured to cause the shut-off valve to function when the pressing motion is canceled by receiving an emergency stop command.

15. The internal mixer according to claim 5, wherein the controller is configured to cause the shut-off valve to function when the pressing motion is canceled by receiving an emergency stop command.

16. The internal mixer according to claim 6, wherein the controller is configured to cause the shut-off valve to function when the pressing motion is canceled by receiving an emergency stop command.

17. The internal mixer according to claim 1, further comprising:
a position detector for detecting a position of the weight in a vertical direction, wherein
the hydraulic cylinder includes a first hydraulic room into which hydraulic oil flows when the weight is lowered, and a second hydraulic room into which hydraulic oil flows when the weight is raised,
the hydraulic circuit includes a hydraulic servo-valve capable of adjusting a supply direction and a supply amount of hydraulic oil to the first hydraulic room or the second hydraulic room, a flow control valve that limits a flow rate of the hydraulic oil in a return line through which hydraulic oil flowing out of the first hydraulic room flows to be equal to or less than a predetermined value, and a shut-off valve provided in the return line, and
the controller is configured to, in the motion for suppressing rapid rise,
calculate a moving speed of the weight from a temporal change of the position of the weight detected by the position detector, and control the hydraulic servo-valve so that the upward moving speed of the weight becomes substantially constant and the hydraulic oil flows to the return line, and
control the shut-off valve to shut off flow of the hydraulic oil in the return line.

18. The internal mixer according to claim 1, further comprising:
a position detector for detecting a position of the weight in a vertical direction, wherein
the hydraulic cylinder includes a first hydraulic room into which hydraulic oil flows when the weight is lowered, and a second hydraulic room into which hydraulic oil flows when the weight is raised,
the hydraulic circuit includes a hydraulic servo-valve configured to be capable of switching a supply direction of hydraulic oil to the first hydraulic room or the second hydraulic room, a return line that returns hydraulic oil flowing out of the first hydraulic room to the hydraulic servo-valve, a flow control valve that limits a flow rate of the hydraulic oil flowing through the return line to be equal to or less than a predetermined value, and a shut-off valve provided in a branched line branching from the return line, and
the controller is configured to, in the motion for suppressing rapid rise,
control the hydraulic servo-valve so that the hydraulic oil flows out of the first hydraulic room, a moving speed of the weight is calculated from a temporal change of the position of the weight detected by the position detector, the upward moving speed of the weight becomes substantially constant, and the hydraulic oil flows to the return line, and
control the shut-off valve to shut off flow of the hydraulic oil in the branched line.

19. The internal mixer according to claim 1, further comprising:
a position detector for detecting a position of the weight in a vertical direction, wherein
the hydraulic cylinder includes a first hydraulic room into which hydraulic oil flows when the weight is lowered, and a second hydraulic room into which hydraulic oil flows when the weight is raised,
the hydraulic circuit includes a hydraulic servo-valve configured to be capable of switching a supply direction of hydraulic oil to the first hydraulic room or the second hydraulic room, a return line that returns hydraulic oil flowing out of the first hydraulic room to the hydraulic servo-valve, a flow control valve that limits a flow rate of the hydraulic oil flowing through the return line to be equal to or less than a predetermined value, and a shut-off valve disposed in a pilot line of the hydraulic servo-valve, and
the controller is configured to, in the motion for suppressing rapid rise,
control the hydraulic servo-valve so that the hydraulic oil flows out of the first hydraulic room, a moving speed of the weight is calculated from a temporal change of the position of the weight detected by the position detector, the upward moving speed of the weight becomes substantially constant, and the hydraulic oil flows to the return line, and
control the shut-off valve to shut off flow of the hydraulic oil in the pilot line.
